(19) United States
(12) Patent Application Publication
(10) Pub. No.: US 2011/0025009 A1
(43) Pub. Date: Feb. 3, 2011

(54) Chassis component for an automobile and method for its manufacture

(75) Inventors: HANS-JÜRGEN NEUMANN, BIELEFELD (DE); HERMANN LAUKÖTTER, WADERSLOH (DE); WOLFRAM LINNIG, PADERBORN (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Automobiltechnik GmbH, PADERBORN (DE)

(21) Appl. No.: 12/846,267

(22) Filed: Jul. 29, 2010

(30) Foreign Application Priority Data
Jul. 30, 2009 (DE) 10 2009 035 702.5

(51) Int. Cl. B60G 7/00; B22D 29/00; B22C 9/12; B22C 1/00; B22C 9/00

(52) U.S. Cl. 280/124.1; 164/131; 164/520; 164/40; 164/23

(57) ABSTRACT

The invention relates to a chassis component for an automobile and a method for producing such chassis component. A mineral core body made of silicate is cast inside a light metal casting, and the blank produced in this manner is processed by forging, forming they chassis component 1. The density and strength of the base body of the light metal casting forming the chassis component as well as of the core body can be adjusted during the forging process.

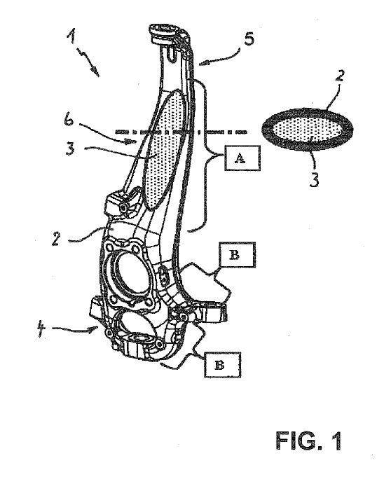

The invention relates to a chassis component for an automobile and to a method for its manufacture.

Light metal and light alloys, in particular aluminum, become increasingly important in the automobile industry as a lightweight construction material, in particular for lightweight chassis components. Because of the elasticity module is smaller than that of steel, the required stiffness of the components requires special cladding-like structures take advantage of the lightweight construction potential of the light metal materials. For highly stressed chassis components, such as hinge bearings, triangular control arms and transverse control arms, which require yield strengths of about 350 MPa at a simultaneously high ductile yield of at least 10%, light metal hollow cast chassis parts can no longer be used or only in limited ways, because these attain yield strengths of only about 200 MPa and ductile yields of about 5%.

It is presently routine to produce such highly stressed chassis components by drop-forging from preformed forging blanks based on extruded profiles. In this context, the so-called Cobapress method is also state-of-the-art. This is a hybrid method where a cast blank is reforged once. The cast structure is hereby compacted by the impact force during drop forging. Porosities typical with castings, shrinkage cavities and other structural defects are comminuted and welded when the material flows during welding, so that the yield strength can be increased to about 280 MPa and the ductile yield to about 10%.

The so-called counterpressure casting is also used in the manufacture of chassis components. In the counterpressure method, an overpressure is produced during the solidification phase of the light metal cast in the mold. This also significantly reduces casting-related porosities, shrinkage cavities and other structural defects and increases the yield strength to about 260 MPa and the ductile yield to about 10%.

The conventional methods have proven successful in operation. However, with the conventional methods, the required component characteristic properties of chassis components can only be realized as solid parts with full cross-sections. The requirements for higher strengths which are limited to certain regions therefore determine the entire component, although the components have other regions where the requirements with respect to strength are reduced, but where a higher stiffness is required. This higher stiffness in certain regions can be with conventional approaches only be achieved by increasing the full cross-sections, which leads to a fundamentally unnecessary increase in weight and material consumption.

It is therefore an object of the invention to obviate the shortcomings of the state-of-the-art and to reduce the weight of highly stressed chassis components with yield strengths between about 280 MPa and 300 MPa and with ductile yields of about 10% or more, while maintaining in all other aspects the requirements for local strength and stiffness, to reduce material consumption and to thereby form the components more economically, and to provide a method for producing a highly stressed lightweight chassis component.

The part of the object relating to the device is attained with a chassis component according to claim 1.

The chassis component according to the invention has a base body of a light metal casting. A mineral core body is embedded by casting in the base body. The base body together with the embedded mineral core body is processed by forging and formed into the chassis component.

Because the stiffness is determined by the third power of the distance to the neutral centerline of the chassis component, the outer cross-sectional regions of the chassis components are particularly important, whereas the inner regions contribute little to the stiffness. This realization forms the basis for the invention. Advantageously, the weight can be reduced while maintaining the same stiffness by designing the components not with full cross-sections, but by at least partially using a light core material in the interior and applying an outer layer which determines the stiffness.

The base body forming the outer cladding of the chassis component is made of a light metal casting. Particularly suitable materials are aluminum and aluminum alloys, or magnesium or magnesium alloys.

A mineral material which is more heat-resistant and lighter than the material of the outer base body made from a light metal casting may be used as the core body. The heat and temperature resistance is such that the core body can be embedded in the molten hot light metal casting. Aluminum or aluminum alloys have a specific weight of about 2.7 g/cm³ and a melting point of about 660° C. Magnesium or magnesium alloys have a specific weight of about 1.7 g/cm³ and a melting point of about 650° C. Preferably, the material to be used as the core body should have a refractory quality to withstand temperatures of 800° C. and higher, in particular a melting point between 1300° C. and 1400° C. In this context, in particular materials based on expanding clay minerals are contemplated. One example of such material is vermiculite.

The core body is particularly arranged in those regions of the chassis component which should have less strength, but the same or a higher stiffness, than other regions of the chassis component.

Preferably, the core body is made of a silicate, in particular of aluminum-iron-magnesium-silicate.

The part of the object relating to the method is attained with a method according to claim 8.

According to the invention, the employed forging blanks are cast parts which are formed in accordance with the component and which have a core body made from lightweight, heat-resistant and thermally stable materials. The core bodies must be able to withstand the subsequent drop forging processes, heat treatments, mechanical machining as well as stress in the chassis component and remain as a permanent core in the chassis component.

According to the invention, the core body is produced by initially providing a rock-like vermiculite starting material. The starting material is ground to a predetermined particle size. The ground vermiculite particles are then processed in a special thermal expansion process, thereby releasing crystalline-bound water. The volume of the vermiculite particles increases when the crystalline-bound water is released. The vermiculite particles treated in this way are then pressed in an additional temperature-pressure controlled processing process with addition of a high-temperature-resistant mineral binder into the desired shape of the core body. A core body produced according to the invention is, depending on the desired shape to be produced, about three times to five times lighter than a conventional component made, for example, from aluminum foam.

To prevent porosities caused by outgassing of the air inclusions contained in the hybrid cores, as well as to protect against damage from transport and handling, surface of the core body may optionally be specially prepared with heat-resistant mineral materials.

The core bodies are arranged in a stable position in a casting mold and subsequently cast and encapsulated in a light metal casting. The position of the core body or bodies is adapted to the later stresses of the finished vehicle component. The core bodies are arranged at those locations where primarily a higher stiffness, rather than a higher strength is required. The core bodies are already positioned in the blank in conformance with the characteristics and the contour of the components. The forging process, for example drop forging, is then performed so that the light metal material and the core body are compacted in a defined manner during forging, whereby the required mechanical properties of the chassis component can be attained or adjusted. The temperatures are defined by the forging process. In practice, the forging temperatures can be assumed to be between 400° C. and 600° C. The blank can be processed by forging after the blank is cast to take advantage of the heat generated in the casting process. In principle, a cold blank for the forging process can also be heated to the forging temperature.

Those regions of the chassis component requiring the highest strength are produced as before with a full cross-section. The material attains the highest strength in these component regions through a corresponding material flow and material compaction during the forging process.

Depending on the requirements, different properties can be intentionally introduced into the chassis components, depending on the positions and the design of the core bodies, on the regions of the chassis components with full cross-section as well as the of the setting of the degree of deformation and the flow characteristic of the forging blank during forging. Depending on the setting for the mechanical properties and the density of the core body before and after forging, an additional inner supporting effect and increase in the stiffness can also be attained in the region of the core body in the chassis component.

The forging process according to the invention is designed to require only a low forming pressure for producing the forged hybrid component in the region of the core body embedded in the forging blank. This results in a very small material flow and likewise a very small material reforming in the forged hybrid component. The hybrid component has therefore locally differentiated required mechanical properties in its finished form, without also upsetting the core body in the forging process so as to increase its density. As a result, a particularly lightweight forged hybrid component with an embedded vermiculite body is produced with the method of the invention.

The invention provides chassis components capable of withstanding high stress with yield strengths to about 280 MPa and ductile yields to about 10%, which also have a lower weight than comparable conventional chassis components. With identical stiffness, the method of the invention is capable of reducing the weight of the chassis components compared to the state-of-the-art. This is not only an important factor for reducing the manufacturing costs, but also an important contribution for reducing the mass of the chassis components, in particular unsprung masses which greatly affect the energy consumption and the driving comfort.

The invention will be described hereinafter with reference to the appended FIGURE.

The FIGURE shows a chassis component according to the invention in form of a forged hinge bearing 1. The hinge bearing 1 includes a base 2 made of a light metal casting. In particular, the base body 2 can be made from aluminum, an aluminum alloy, but also from magnesium or a magnesium alloy. A mineral core body 3 is embedded in the base body 2 by casting.

The core body 3 is made from a silicate, in particular from an aluminum-iron-magnesium-silicate.

The FIGURE illustrates that the core body 3 is arranged in a center region 6 of the component which extends between the lower region 4 of the component and an upper region 5 of the component. This longitudinal extent of this region 6 of the component is indicated with the reference symbol A. The core body 3 is schematically illustrated in the FIGURE in combination with an illustration of a cross-section through the region 6 of the component. The region A of the component has particularly high stiffness requirements. In this region, the core body 3 can reduce the weight while maintaining a high stiffness. The regions of the component indicated in the FIGURE with the reference symbol B are subject to primary strength requirements. For this reason, the regions B of the component are produced in a conventional manner with a full cross-section.

For producing the hinge bearing 1, a prefabricated mineral core body 3 is provided with a geometry adapted to the subsequent use in the chassis component. This core body 3 is positioned in a casting mold and cast in a molten light metal casting and thus embedded in the light metal casting. The blank produced in this manner is then machined by forging, thereby forming the hinge bearing 1. During the forging process, the density and/or the strength of the hinge bearing 1 are intentionally adjusted. The blank can be processed by forging after the blank is cast, using thermal energy from the casting process. However, a cooled blank can also be heated for the forging process to the forging temperature.

### LIST OF REFERENCE SYMBOLS

1 Hinge bearing
2 Base body
3 Core body
4 Lower region of the component of 1
5 Upper region of the component of 1
6 Center region of the component of 1
A Region of the component
B Region of the component

What is claimed is:

1.-16. (canceled)

17. A chassis component for an automobile, comprising:
a base body made of a light metal casting, and
at least one mineral core body embedded in the base body,
wherein the base body is cast around the at least one mineral core and the chassis component is formed by forging.

18. The chassis component of claim 17, wherein the core body comprises silicate.

19. The chassis component of claim 17, wherein the core body comprises vermiculite.

20. The chassis component of claim 19, wherein the vermiculite comprises less than 20% crystalline-bound water.

21. The chassis component of claim 19, wherein the vermiculite comprises less than 10% crystalline-bound water.

22. The chassis component of claim 19, wherein the vermiculite comprises less than 5% crystalline-bound water.

23. The chassis component of claim 17, wherein the core body comprises aluminum-iron-magnesium-silicate.

24. The chassis component of claim 17, wherein the core body comprises aluminum or an aluminum alloy.

25. The chassis component of claim 17, wherein the core body comprises magnesium or a magnesium alloy.

26. The chassis component of claim 17, wherein the core body is arranged in a region of the chassis component, which has less strength, but identical or higher stiffness, than another region of the chassis component.

27. A method for producing a chassis component, comprising the steps of:
providing a mineral core body;
casting the core body in a light metal casting to produce a blank; and
processing the blank by forging to form the chassis component.

28. The method of claim 27, further comprising the steps of:
grinding rock-like vermiculite; and
producing the mineral core body from the ground vermiculite.

29. The method of claim 28, further comprising the step of releasing crystalline-bound water residing in the ground vermiculite in a thermal expansion process.

30. The method of claim 29, further comprising the step of pressing the vermiculite into a desired shape commensurate with the core body in a temperature-dependent pressure process with addition of a high-temperature-resistant mineral binder.

31. The method of claim 30, further comprising the step of preparing a surface of the shaped core body with a heat-resistant mineral material.

32. The method of claim 27, wherein the core body is made from silicate.

33. The method of claim 27, wherein the core body is made from aluminum-iron-magnesium-silicate.

34. The method of claim 27, wherein the light metal casting comprises aluminum or an aluminum alloy.

35. The method of claim 27, wherein the light metal casting comprises magnesium or a magnesium alloy.

36. The method of claim 27, wherein a density or a strength, or both, of the core body are adjusted during forging.

37. The method of claim 27, wherein the blank is forged at a temperature between 400° C. and 600° C.
